(19) United States
(12) Patent Application Publication
(10) Pub. No.: US 2025/0181109 A1
(43) Pub. Date: Jun. 5, 2025

(54) ELECTRONIC DEVICE

(71) Applicant: Lenovo (Beijing) Limited, Beijing (CN)

(72) Inventors: Chong-xian WU, Beijing (CN); Sai GAO, Beijing (CN)

(21) Appl. No.: 18/938,266

(22) Filed: Nov. 5, 2024

(30) Foreign Application Priority Data
Nov. 30, 2023 (CN) 202311636046.8

(51) Int. Cl. G06F 1/16

(52) U.S. Cl. CPC G06F 1/1624; G06F 1/1616

(57) ABSTRACT

An electronic device includes a first body and a second body. The first body includes a target housing in contact with a supporting surface. The target housing includes a target member and a Base member forming the first body. The second body is rotatably connected to the first body. A weight of the first body is smaller than a weight of the second body. In response to the electronic device being in a first device attitude, the second body covers the target member. In response to the electronic device being in a second device attitude, the second body has a target angle with the first body. The target member is configured to support the electronic device to be in the second device attitude to reduce an impact when the weight of the first body is smaller than the weight of the second body.

### CROSS REFERENCE TO RELATED APPLICATION

The present disclosure claims priority to Chinese Patent Application No. 202311636046.8, filed on Nov. 30, 2023, the entire content of which is incorporated herein by reference.

### TECHNICAL FIELD

The present disclosure is related to the electronic technical field and, more particularly, to an electronic device.

### BACKGROUND

Electronic devices such as laptop computers are often placed on a desktop, and users can obtain a comfortable angle for viewing the screen by adjusting the positions of the electronic devices. With increasing number of functional members of the electronic devices, when a supporting member (e.g., a keyboard) of the electronic devices placed on the desk is lighter than a supported member (e.g., a screen), to ensure the electronic devices are stably placed without tipping, the forms of the electronic devices are limited. This is not convenient for the user. Thus, how to improve the electronic devices to avoid the above deficiencies is an interesting problem for those skilled in the art to solve.

### SUMMARY

An aspect of the present disclosure provides an electronic device including a first body and a second body. The first body includes a target housing in contact with a supporting surface. The target housing includes a target member and a Base member forming the first body. The second body is rotatably connected to the first body. A weight of the first body is smaller than a weight of the second body. In response to the electronic device being in a first device attitude, the second body covers the target member. In response to the electronic device being in a second device attitude, the second body has a target angle with the first body. The target member is configured to support the electronic device to be in the second device attitude to reduce an impact when the weight of the first body being smaller than the weight of the second body.

### BRIEF DESCRIPTION OF THE DRAWINGS

FIG. 1 illustrates a schematic side view of an electronic device according to some embodiments of the present disclosure.

FIG. 2 illustrates a schematic diagram showing an electronic device being applied in a first device attitude according to some embodiments of the present disclosure.

FIG. 3 illustrates a schematic diagram showing an electronic device being applied in a second device attitude according to some embodiments of the present disclosure.

FIG. 4 illustrates a schematic diagram showing an electronic device being applied in a second device attitude after being partially cut according to some embodiments of the present disclosure.

FIG. 5 illustrates a schematic bottom view of the electronic device in the status shown in FIG. 1.

FIG. 6 illustrates a schematic diagram showing an electronic device being applied in a second device attitude according to some embodiments of the present disclosure.

FIG. 7 illustrates a schematic diagram showing a footpad of an electronic device according to some embodiments of the present disclosure.

### REFERENCE NUMERALS

| | | |
|---|---|---|
| 1 First body | 11 Base member, | 111 Third foot pad |
| 12 Target member | 121 End surface | 122 Second foot pad |
| 2 Second body | 21 First sub-body | 211 Groove |
| 212 First footpad | 22 Second sub-body | |

### DETAILED DESCRIPTION OF THE EMBODIMENTS

The present disclosure provides an electronic device. The electronic device can allow a user to adjust the form of the electronic device in a wide range, even when a supporting member is lighter than a supported member. Thus, the above inconvenience to the user due to the weight situation can be reduced.

The technical solution of embodiments of the present disclosure is described in detail in connection with the accompanying drawings of embodiments of the present disclosure. The embodiments described are merely some embodiments of the present disclosure, not all embodiments. Based on embodiments of the present disclosure, all other embodiments obtained by those skilled in the art without creative effort are within the scope of the present disclosure.

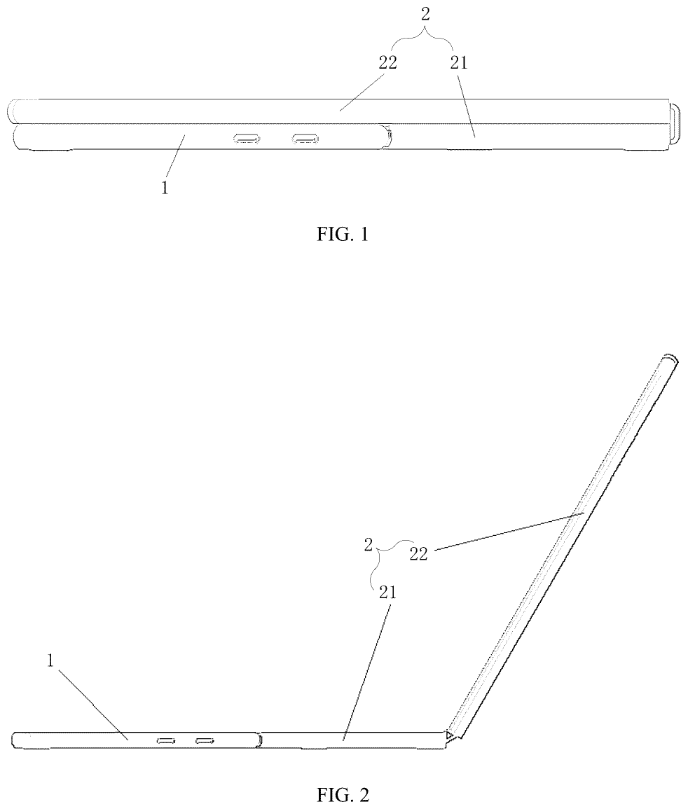

As shown in FIG. 1 to FIG. 5, embodiments of the present disclosure provide an electronic device. The electronic device can include a laptop computer, a tablet computer, a cell phone, etc. The electronic device includes a first body 1 and a second body 2 rotatably connected to the first body 1. The weight of the first body 1 is lighter than the weight of the second body 2. The first body 1 includes a target housing configured to be in contact with a supporting surface, such as a desk surface. The target housing can be the housing member of the first body 1 facing the supporting surface. The target housing includes a target member 12 and a Base member 11 forming the first body 1. When the electronic device is in a first device attitude, the second body 2 can cover the target member 12. That is, the target member 12 can be between the second body 2 and the supporting surface and covered by the second body 2. When the electronic device is in a second device attitude, the second body 2 can have a target angle relative to the first body 1. The target angle can be an angle represented in the relative position relationship of the second body 2 and the first body 1 after the user rotates the second body 2 relative to the first body 1 to obtain a comfortable viewing angle for the second body 2. The target member 12 can be configured to support the electronic device to be in the second device attitude to reduce the impact when the weight of the first body 1 is lighter than the weight of the second body 2. That is, in the second device attitude, the target member 12 of the first body 1 can support the electronic device. With the supporting function, the weight of the first body 1 being lighter than the weight of the second body 2 may not have too much impact on the adjustable range of the target angle. Thus, when the weight of the first body 1 is lighter than the weight of the second body 2, the user can still adjust and rotate the second body 2 relative to the first body 1 in a wide range, which may not cause the electronic device to tip. Therefore, compared to the existing electronic device, with the electronic device in embodiments of the present disclosure, the inconvenience caused by the above weight situation to the user can be reduced.

In some embodiments, the second body 2 includes a first sub-body 21, a second sub-body 22, and a display. The weight of the first sub-body 21 is smaller than or equal to the weight of the first body 1. The weight of the second body 2 can include the weight of the second sub-body 22 and the weight of the first sub-body 21. The first sub-body 21 can be movably connected to the second sub-body 22. The display can cover the first sub-body 21 and the second sub-body 22. The display can deform based on the movable connection between the first sub-body 21 and the second sub-body 22. That is, the second body 2 can include the first sub-body 21 and the second sub-body 22 that can move relatively, and the display covering the first sub-body 21 and the second sub-body 22. By causing the first sub-body 21 and the second sub-body 22 to move relatively, the form of the display can be changed. The deformation of the display can include variations in the shape and/or size of the display area. In some embodiments, the first sub-body 21 and the second sub-body 21 can include a plurality of types of movable connections. For example, the first sub-body 21 and the second sub-body 22 can be slidingly connected, and the second body 2 can be then configured as a retractable structure. For another example, the first sub-body 21 and the second sub-body 22 can be rotatably connected, and the second body 2 can be then configured as a foldable structure. For another example, the first sub-body 21 and the second sub-body 22 can be rotatably and slidingly connected, and the second body 2 can be then configured as a retractable and foldable structure. That is, the axis of the relative rotation of the first sub-body 21 and the second sub-body 22 can have a relative position with the first sub-body 21 or the second sub-body 22 changing as the second body 2 retracts and extends.

In some embodiments, the weight of the second sub-body 22 can be smaller than the weight of the first body 1. Since the weight of the second body 2 includes the weight of the first sub-body 21 and the weight of the second sub-body 22, the sum of the weight of the first sub-body 21 and the weight of the second sub-body 22 can be greater than the weight of the first body 1. The device attitude of the electronic device still needs to be supported by the target member 12.

In some embodiments, the second body 2 can have a retractable function based on the movable connection between the first sub-body 21 and the second sub-body 22. When the electronic device is in the second device attitude, the target member 12 can be at least configured to support the second body 2 with the first sub-body 21 and the second sub-body 22 in a retracted state. The target angle can belong to a first range. That is, when the first sub-body 21 and the second sub-body 22 are in the retracted state, the overall size of the second body 2 can be reduced. Then, in the second device attitude, the angle represented in the relative position relationship of the first body 1 and the second body 2 can change in the first range. The change can be realized by the user rotating the second body 2 relative to the first body 1. For example, the user can press the first body 1 with one hand, and push or pull the second body 2 away from the first body 1 with another hand. Thus, the second body 2 can rotate relative to the first body 1.

When the electronic device is in the second device attitude, the target member 12 can at least be configured to support the second body 2 with the first sub-body 21 and the second sub-body 22 in an expanded state. The target angle can belong to a second range. The second range can be smaller than the first range. That is, when the first sub-body 21 and the second sub-body 22 are in the expanded state, the overall size of the second body 2 can become larger. Then, in the second device attitude, the angle represented in the relative position relationship of the first body 1 and the second body 2 can change in the second range. Since in the second device attitude, the overall center of gravity can be raised as the first sub-body 21 and the second sub-body expand. Thus, to avoid the impact on the stability of the second device attitude due to the change in the center of gravity, the second range can be smaller than the first range.

In some embodiments, the second body 2 can have a retractable function based on the movable connection of the first sub-body 21 and the second sub-body 22. In some embodiments, when the first sub-body 21 and the second sub-body 22 are in the retractable state, the display can be a first display output area. When the first sub-body 21 and the second sub-body 22 are in the expanded state, the display can be a second display output area. The second display output area can include the first display output area. That is, after the second body 2 is retracted, the overall size of the second body 2 can become smaller. Then, the display can provide the first display output area with a relatively small area. After the second body 2 is expanded, the overall size of the second body 2 can become larger. Then, the display can provide the second display output area with a relatively large area. For example, the display can be set as a flexible screen that can curl and deform. A reel can be arranged inside the first sub-body 21 and/or the second sub-body 22 and configured to wind the display. When the second body 2 is retracted, the reel can wind a larger portion of the display. Then, the portion of the display exposed outside the second body 2, i.e., the display output area, can be reduced. When the second body 2 expands, the reel can release the portion of the display inside the second body 2. Then, the portion of the display exposed outside the second body 2 can be increased. That is, the display output area can become larger.

In some embodiments, from the retracted state of the first sub-body 21 and the second sub-body 22 of the second body 2 to the expanded state of the first sub-body 21 and the second sub-body 22 of the second body 2, the center of gravity of the second body 2 can change. The target member 12 can at least be configured to support the electronic device to be in the second device attitude and support the first sub-body 21 and the second sub-body 22 from being in the retracted state to the expanded state. The change in the center of gravity of the second body 2 can indicate that the position of the center of gravity of the second body 2 can change as the state of the second body 2 changes. For example, when the first sub-body 21 and the second sub-body 22 are in the retracted state, the first sub-body 21 and the second sub-body 22 can have an overlapped part. The center of gravity of the second body 2 can be at the overlapped part. When the first sub-body 21 and the second sub-body 22 are in the expanded state, the first sub-body 21 and the second sub-body 22 may not have the overlapped part. Then, the center of gravity of the second body 2 can be at the border between the first sub-body 21 and the second sub-body 22. The position of the center of gravity of the second body 2 can be related to the weight situation of the first sub-body 21 and the second sub-body 22. With different weight situations, the center of gravity of the second body 2 can be at the first sub-body 21 or the second sub-body 22. The target member 12 can be at least configured to support the electronic device to be in the second device attitude. That is the change in the center of gravity of the second body 2 may not affect the target member 12 stably supporting the electronic device. The electronic device can still be stably placed on the supporting surface with the supporting function of the target member 12. The target member 12 can be at least configured to support the electronic device to be in the second device attitude. Thus, the target member 12 can support the second body 2 with the first sub-body 21 and the second sub-body 22 in the retracted state, and support the second body 2 with the first sub-body 21 and the second sub-body 22 in the expanded state. In addition, the target member 12 can at least be configured to support the first sub-body 21 and the second sub-body 22 from the retracted state to the expanded state. That is, the target member 12 can support the change process of the retraction and expansion of the second body 2 to cause the second body 2 to change state smoothly.

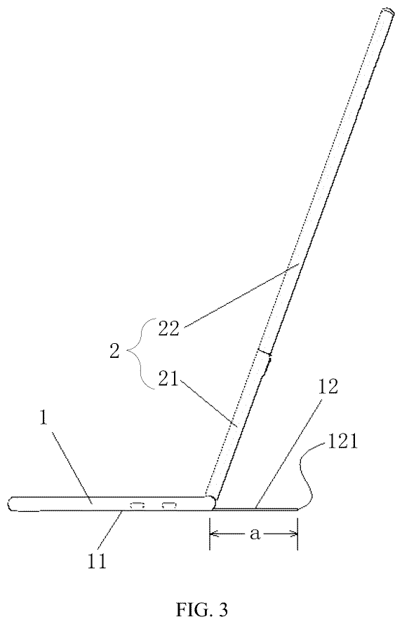

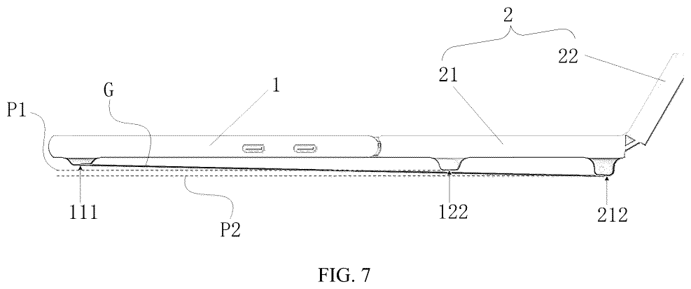

In some embodiments, the second body 2 can have a foldable function (or bendable) based on the movable connection between the first sub-body 21 and the second sub-body 22. In some embodiments, when the electronic device is in the first device attitude, the first sub-body 21 can cover the target member 12. The second sub-body 22 and the first sub-body 21 can have a first angle. The first angle can belong to the first range. When the electronic device is in the second device attitude, the first angle between the first sub-body 21 and the second sub-body 22 can satisfy a target value. The target member 12 can at least be configured to support the second device attitude with the first angle between the first sub-body 21 and the second sub-body 22 satisfying the target value. That is, in the first device attitude, the first sub-body 21 can cover the target member 12 of the first body 1. As shown in FIG. 2, the user uses the first device attitude of the electronic device, e.g., a laptop mode. The relative position between the second sub-body 22 and the first sub-body 21 can be adjusted in a certain range. For example, the second sub-body 22 is pushed to the left direction in FIG. 2 to cause the first angle between the second sub-body 22 and the first sub-body 21 to become smaller. In the second device attitude, the first angle between the first sub-body 21 and the second sub-body 22 can also be adjusted. The first angle can be adjusted to the target value without affecting the stability of the second device's attitude. As shown in FIG. 3, the user uses the vertical mode of the electronic device. The first angle between the first sub-body 21 and the second sub-body 22 is adjusted to the target value of 180° in FIG. 3, or other target values smaller than 180°, such as 150° and 160°. When the first angle between the first sub-body 21 and the second sub-body 22 is adjusted to be smaller than 180°, the overall electronic device can have two bends. One bend can be at the border between the first body 1 and the first sub-body 21, and the second bend can be at the border between the first sub-body 21 and the second sub-body 22. For example, the second sub-body 22 in FIG. 3 is rotated in a counterclockwise direction relative to the first sub-body 21 to rotate the second sub-body 22 to a position perpendicular to the first body 1. Then, as shown in FIG. 6, the user can view the output content of the electronic device using a bent display. In some embodiments, a first portion screen and a second portion screen can display the output content independently. The first portion screen can be the portion of the display covering the first sub-body 21, and the second portion screen can be the portion of the display covering the second sub-body 22. For example, the first portion screen can display the interface of the first application, and the second portion screen can display the interface of the second application.

In some embodiments, the first body 1 can be connected to the first sub-body 21 through a first connection apparatus. The first sub-body 21 can be connected to the second sub-body 22 through a second connection apparatus. When the electronic device is in a third device attitude, the second portion of the second sub-body 22 can cover the first portion screen of the first sub-body 21 and the input surface of the first body 1. That is, the first sub-body 21 can be closer to the first body 1 compared to the second sub-body 22. As shown in FIG. 1, when the second sub-body 22 is bent to the extreme position toward the direction of the first body 1 relative to the first sub-body 21, the first sub-body 21 and the first body 1 can be between the second sub-body 22 and the supporting surface and can be covered by the second sub-body 22. The input surface of the first body 1 can be the surface of the first body 1 on which the input assembly such as the keyboard is arranged. In some embodiments, the size of the second portion screen can be equal to the sum of the size of the first portion screen and the size of the input surface. That is, the second portion screen can completely cover the first portion screen and the input surface of the first body 1 simultaneously. In some embodiments, the size of the second portion screen can be close to the sum of the size of the first portion screen and the size of the input surface. For example, the size of the second portion screen can be larger than the sum of the size of the first portion screen and the size of the input surface. As shown in FIG. 1, in the third device attitude, the second body 22 can be slightly larger than the sum of the size of the first portion screen and the size of the input surface. In the third device attitude, the second sub-body 22 can slightly extend out of the first body 1. Thus, the user can conveniently lift the second sub-body 22 upward through a finger.

As shown in FIG. 3, when the electronic device is in the second device attitude, the target angle of the second body 2 relative to the first body 1 belongs to the target range. Moreover, the target member 12 can expand upwardly in the target direction away from the first body, and the distance of the Base member 11 can be related to the target range. That is, when the distance a is large, the second body 2 can rotate in a large range relative to the first body 1 and maintain the stability of the second device's attitude. When the distance a is relatively small, the second body 2 can rotate in the small range to ensure the stability of the second device's attitude.

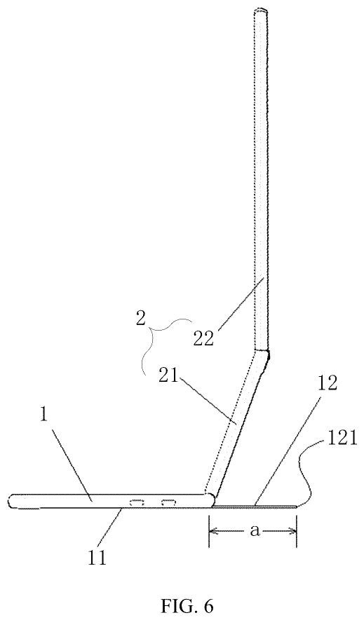

As shown in FIGS. 3 and 5, in some embodiments, the member 11 and the target member 12 are integrally formed. Thus, the size of the target member 12 can be a fixed value. That is, when the electronic device is used, the distance a in FIG. 3 may not change. When the size of the target member 12 is larger, the second body 2 can be opened with a larger angle relative to the first body 1 without tipping. For example, when the distance a is 45 mm, the second body 2 can be opened backward at most to 140° without tipping. When the distance a is 63 mm, the second body 2 can be opened backward at most to 170° without tipping. The largest angle that the second body 2 can be opened relative to the first body 1 without tipping can be increased by 30°. In some embodiments, the size of the target member 12 can be set to be the same as the length of the second body 2. Thus, the second body 2 can be backwardly opened to any angle relative to the first body 1 without tipping.

In some embodiments, the target member 12 and the Base member 11 can be configured to have the sliding connection to cause the target member 12 to move along the direction in parallel to the target direction relative to the Base member 11 to change the distance a. For example, a motor configured to drive the target member 12 to move relative to the Base member 11 can be arranged inside the first body 1. The motor can be electrically connected to the sensor that can sense the relative rotation between the first sub-body 21 and the first body 1. When the second body 2 rotates along the clockwise direction relative to the first body 1 in FIG. 3, the motor can drive the target member 12 to move along the above target direction to increase the distance a. When the second body 2 rotates along the counterclockwise direction relative to the first body 1 in FIG. 3, the motor drives the target member 12 to move along the opposite direction of the target direction to decrease the distance a.

In some embodiments, the weight of the first sub-body 21 can be smaller than the weight of the first body 1. The weight of the first sub-body 21 can be smaller than the weight of the second sub-body 22. Thus, the second center of gravity of the second body 2 with the first angle between the first sub-body 21 and the second sub-body 22 satisfying the target value can be caused to be at the second connection apparatus. As shown in FIG. 3, in some embodiments, the size of the second sub-body 22 is larger than the size of the first sub-body 21, and the second connection apparatus is at the second sub-body 22. That is, the main member including the rotation shaft of the second connection apparatus can be arranged inside the second sub-body 22 to cause the center of gravity of the second body 2 (i.e., the center of the mass of the second body 2) to be at the second connection apparatus. In some other embodiments, the center of gravity of the second body 2 can be at the first sub-body 21 or the second sub-body 22.

In some embodiments, when the electronic device is in the second device attitude, the first distance from the first center of gravity of the first body 1 to the end surface 121 of the target member 12 can be greater than the second distance. The second distance can be the distance from the projection point by projecting the second center of gravity of the second body 2 to the supporting surface to the end surface 121 of the target member 12. The first distance can be greater than the second distance corresponding to any angle in the target range. That is, in the second device attitude, the second body 2 can be rotated relative to the first body 1, as long as the angle of the second body 2 relative to the first body 1 does not exceed the target range. The distance between the center of gravity of the second body 2 and the end surface 121 of the target member 12 in the horizontal direction can be always smaller than the distance between the center of gravity of the first body 1 and the end surface 121 of the target member 12 in the horizontal direction. During the application process, the first center of gravity of the first body 1 and the second center of gravity of the second body can be on the same side of the end surface 121 or two sides of the end surface 121. No matter whether the first center of gravity and the second center of gravity are on the same side or on different sides of the end surface 121, the first distance can be greater than the second distance.

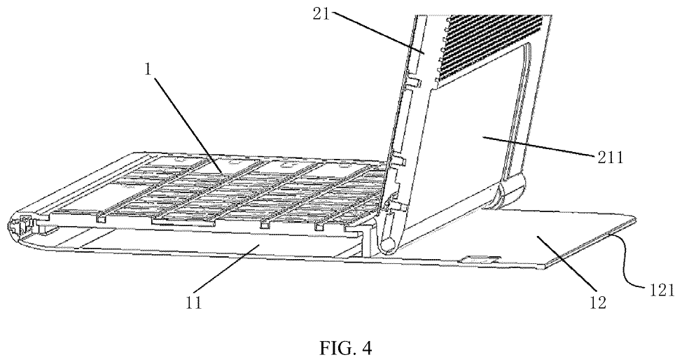

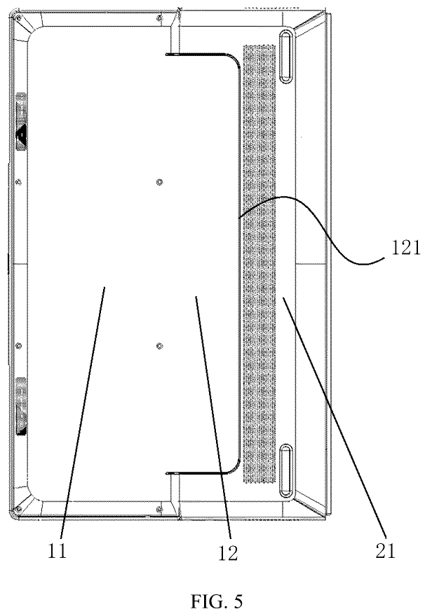

As shown in FIG. 4 and FIG. 5, in some embodiments, a groove 211 is formed on the surface of the second body 2. When the electronic device is in the first device attitude, the target member 12 of the first body 1 can be accommodated in the groove 211. In some embodiments, the groove 211 can be arranged on the surface of the first sub-body 21 facing away from the display. The first sub-body 21 can support the first device attitude of the electronic device with the Base member 11 and the target member 12 of the first body 1 together to cause the first device attitude to be more stable. That is, the electronic device in the first device attitude may not tip. In some embodiments, the shape of the groove 211 can match the contour shape of the target member 12. As shown in FIG. 5, in the first device attitude, the target member 12 can fill the groove 211.

As shown in FIG. 2 and FIG. 7, in some embodiments, the second body 2 includes a column-shape first foot pad 212, and the first body 1 includes a column-shape second foot pad 122 and a third foot pad 111. The second foot pad 122 is arranged at the target member 12, and the third foot pad 111 is arranged at the Base member 11. As shown in FIG. 7, with the auxiliary line, plane P1 passes the supporting end of the second foot pad 122 and is in parallel with the plane formed by the first body 1 and the first sub-body 21. Plane P2 passes through the supporting end of the first foot pad 212 and is in parallel with the plane formed by the first body 1 and the first sub-body 21. The heights of the first foot pad 212, the second foot pad 122, and the third foot pad can be reduced in sequence. In the first device attitude, the supporting end of the first foot pad 212 and the supporting end of the third foot pad 111 can be co-tangent with plane G and form the first space with the surface of the first body. The second foot pad 122 can be between the first foot pad 212 and the third foot pad 111 in the direction from the second body 2 to the first body 1. Thus, no matter whether the electronic device is applied in the first device attitude or the second device attitude, the footpad can form a stable support.

In the specification, some structures are described in a progressive manner. Each structure focuses on the difference from the existing structure. The overall and a part of structures of the electronic device can be obtained by combining the plurality of structures.

The above descriptions of embodiments of the present disclosure can enable those skilled in the art to implement or use the present disclosure. Various modifications to these embodiments are obvious to those skilled in the art. The general principles defined herein may be applied to other embodiments without departing from the spirit or scope of the present disclosure. Therefore, the present disclosure should not be limited to the embodiments shown here but should conform to the broadest scope consistent with the disclosed principles and novel features of the present disclosure.

What is claimed is:

1. An electronic device comprising:
a first body including a target housing in contact with a supporting surface, the target housing including a target member and a Base member forming the first body; and
a second body rotatably connected to the first body, a weight of the first body being smaller than a weight of the second body;
wherein:
in response to the electronic device being in a first device attitude, the second body covers the target member;
in response to the electronic device being in a second device attitude, the second body has a target angle with the first body, and the target member is configured to support the electronic device to be in the second device attitude to reduce an impact when the weight of the first body being smaller than the weight of the second body.

2. The device according to claim 1, wherein the second body further includes:
a first sub-body, a weight of the first sub-body being smaller than or equal to the weight of the first body;
a second sub-body, the weight of the second body including the weight of the first sub-body and a weight of the second sub-body, and the first sub-body being movably connected to the second sub-body; and
a display covering the first sub-body and the second sub-body, the display deforming based on a movable connection between the first sub-body and the second sub-body.

3. The device according to claim 2, wherein:
in response to the electronic device being in the second device attitude, the target member is at least configured to support the second body with the first sub-body and the second sub-body in a retracted state, the target angle belonging to a first range; and
in response to the electronic device being in the second device attitude, the target member is at least configured to support the second body with the first sub-body and the second sub-body in an expanded state, the target angle belonging to a second range smaller than the first range.

4. The device according to claim 2, wherein:
from the first sub-body and the second sub-body of the second body in a retracted state to an expanded state, a center of gravity of the second body changes, the target member is at least configured to support the electronic device to be in the second device attitude, and the first sub-body and the second sub-body are from being in the retracted state to the expanded state.

5. The device according to claim 2, wherein:
in response to the electronic device being in the first device attitude, the first sub-body covers the target member, the second sub-body and the first sub-body have a first angle belonging to a first range; and
in response to the electronic device being in the second device attitude, a first angle between the first sub-body and the second sub-body satisfies a target value, the target member is at least configured to support the second device attitude with the first angle between the first sub-body and the second sub-body satisfying the target value.

6. The device according to claim 5, wherein:
the first body is connected to the first sub-body through a first connection apparatus, and the first sub-body is connected to the second sub-body through a second connection apparatus; and
in response to the electronic device being in a third device attitude, a second portion screen of the second sub-body covers a first portion screen of the first sub-body and an input surface of the first body.

7. The device according to claim 6, wherein a size of the second portion screen is equal to a sum of a size of the first portion screen and a size of the input surface.

8. The device according to claim 6, wherein:
in response to the electronic device being in the second device attitude, a target angle of the second body relative to the first body belongs to a target range; and
a distance that the target member extends out of the Base member in a target direction away from the first body is related to the target range.

9. The device according to claim 8, wherein:
the weight of the first sub-body is smaller than the weight of the first body;
the weight of the first sub-body is smaller than the weight of the second sub-body;
a second center of gravity of the second body with the first angle between the first sub-body and the second sub-body satisfying the target value is at the second connection apparatus.

10. The device according to claim 9, wherein:
in response to the electronic device being in the second device attitude, a first distance from a first center of gravity of the first body to an end surface of the target member is greater than a second distance; and
the second distance is a distance from a projection point of a projection of the second center of gravity of the second body to the supporting surface to the end surface of the target member, and the first distance is greater than second distance corresponding to any angle in the target range.
